(19) United States
(12) Patent Application Publication
(10) Pub. No.: US 2010/0316270 A1
(43) Pub. Date: Dec. 16, 2010

(54) 3D RECONSTRUCTION OF A BODY AND OF A BODY CONTOUR

(75) Inventors: Klaus Erhard, Hamburg (DE); Michael Grass, Buchholz In Der Nordheide (DE); Dirk Schaefer, Hamburg (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/808,682

(22) PCT Filed: Dec. 16, 2008
(86) PCT No.: PCT/IB08/55350

§ 371 Date: Jun. 17, 2010

(30) Foreign Application Priority Data
Dec. 20, 2007 (EP) 07123881.0
Oct. 10, 2008 (EP) 08166336.1

(51) Int. Cl. G06K 9/00

(52) U.S. Cl. 382/128

(57) ABSTRACT

The invention proposes a 3D reconstruction of a body and a body contour from transversally truncated projections using a polyhedral object model. Possible clinical applications arise in the field of guided biopsies on acquisition systems equipped with a flat panel detector, where truncated projections cannot be avoided in thorax and abdominal scan protocols. From, for example, a rotational run both a 3D volume reconstruction and a surface mesh reconstruction of a patient's shape is generated and then visualized simultaneously in order to help the physician guide the biopsy device and judge the distance from the patient's skin to the tissue of interest inside the reconstructed volume.

The invention relates to the field of medical imaging. In particular, the invention relates to an examination apparatus for 3D reconstruction of a body and of a body contour, to a method for 3D reconstruction of a body and of a body contour, a computer-readable medium, a program element and an image processing device.

Beside other applications, the embodiments according to the invention are especially useful for guided biopsy.

High contrast imaging is an important clinical application of, most of all, X-ray systems providing the physicians with valuable information for diagnosis. Often, the physicians are interested in only a few two-dimensional fluoroscopies acquired from different angles in order to keep the dose applied on the patient as small as possible or due to mechanical restrictions at bed side or in the operating room.

Another example stems from rotational angiography of the vessel tree. Although the number of measured projections may vary from 80 to 200, the projections belonging to one cardiac phase are significantly less, for example in the order of 4 to 10. However, three-dimensional reconstructions from a limited number of projections with standard filtered back-projection techniques (FBP) may be blurred. Iterative maximum likelihood (ML) algorithms may improve the signal-to-noise ratio but without additional regularization a reasonable reconstruction may not be possible.

In recent years there has been some progress in reconstructing sparse objects such as bolus filled vessels. Another technique based on polyhedral object models has been presented, in which the attenuation value is a known value. Both techniques make use of a priori knowledge such as “sparseness” or the polyhedral nature of the object in order to stabilize the reconstruction.

In case of biopsies, those high contrast images might be used prior to the actual taking of the biopsy sample, i.e. for planning the same.

For correct diagnosis of various cancer diseases biopsies are taken. This can either be done via a lumen of an endoscope or via needle and catheter biopsies. In order to find the correct position to take the biopsy, various imaging modalities are used such as X-ray, CT, MRI and ultrasound. In case of, for example, prostate cancer in most cases the biopsy is guided by ultrasound. Although helpful, these methods of guidance are far from optimal.

The problem directly related to the biopsy, is, that the resolution of the imaging system is limited and, therefore, the biopsies are often taken blindly, with limited feedback of where the needle is relative to the target tumor, which leads to an additional uncertainty whether the lesion has been hit by the needle. It is clear that guidance improvement is required to target the biopsy needle to the correct position in the tissue.

A way to solve the navigation towards the suspicious tissue is by navigating the biopsy needle tip by employing, for example, electromagnetic guidance. However the accuracy of the method is limited to a few millimeters. As a result for small sized suspicious tissue volumes there is a certain chance of taking the biopsy at the wrong place. A further limitation is that even if one could guide the biopsy needle to the exact location corresponding to the pre-recorded image, one is never sure that this is the exact location due to the compressibility of the tissue. Due to the force of the biopsy needle on the tissue during advancement, the tissue may become deformed.

If the specimen taken appears to be cancerous, in most cases this cancerous tissue will be removed by surgery (especially when the tumor is well localized) or treated percutaneously using RF, microwave, or cryoablation.

The surgical approach is confounded by the fact that the surgeons typically use only their eyes and hands (palpation) to find the tumor and have to rely on the information of pre-recorded images. These pre-recorded images provide information on the position of the tumor but do not always clearly show the tumor boundaries. Sometimes, the surgeon implants a marker under image guidance, providing him or her with a reference point to focus on during the surgical procedure. Again guiding the localization wire to the correct position is difficult.

The biopsy device may also be used as a device for administering drugs or a therapy (like ablation) at a certain position in the body without removing tissue, for instance for injecting a fluid at the correct location of the affected body part. The same drawbacks apply for these interventions where it is difficult to guide the biopsy device to the correct location.

Accordingly, the current way of working to take a biopsy sample has the drawback, that it is difficult to guide the biopsy device, preferably, to a centre of the tissue to be investigated.

It would be desirable to have an improved modelling of a body as well as of a body contour of an object of interest, as a basis for an improved biopsy guidance. Furthermore, it would be desirable to have an apparatus by means of which the location of a biopsy device can be intra-operatively located and tracked, i.e. during the taking of a biopsy sample.

The invention provides an examination apparatus, a method, an user interface, a computer-readable medium, and an image processing device with the features according to the respective independent claims.

The invention proposes a reconstruction of a patient's shape from transversally truncated projections using a polyhedral object model. Possible clinical applications arise in the field of guided biopsies on acquisition systems equipped with a flat panel detector, where truncated projections cannot be avoided in thorax and abdominal scan protocols. From a rotational run both a 3D volume reconstruction and a surface mesh reconstruction of a patient's shape is generated and then visualized simultaneously in order to help the physician guide the biopsy device and judge the distance from the patient's skin to the tissue of interest inside the reconstructed volume.

Generally, an examination apparatus according to the invention, for 3D reconstruction of a body and of a body contour of an object of interest, comprises a data acquisition device for acquisitioning of projection data of the object of interest, a calculation unit adapted for performing the steps of reconstructing of a region of interest, and reconstructing of a homogeneous polyhedron outside the region of interest, and a display device for displaying a combined visualization of the reconstructed region of interest and the reconstructed polyhedron.

The step of reconstructing of a homogeneous polyhedron includes, according to another embodiment of the invention, forward projecting of a reconstructed attenuation function of the region of interest, subtracting the result from the acquired projection data to generate a target function, forward projecting of a polyhedral model consisting of a body contour sub-model and a region of interest sub-model with a constant attenuation function inside each of the sub-models. Furthermore the step of reconstructing of a homogeneous polyhedron includes an optimization step, in which a homogeneous polyhedron model is optimized by minimization of the residual between the forward projected model and the target function.

It should be noted that the forward projection of a reconstructed attenuation function is performed substantially inside the region of interest. Furthermore, the body contour, and also the region of interest, might be sub-divided in several sub-models, such that the polyhedral model consists of several body contour sub-models and of at least one region of interest sub-model.

According to another embodiment of the invention, a user interface for visualization of 3D reconstruction of a body and of a body contour is proposed, wherein the visualization and the data reconstructions are performed after an acquisition of projection data of the object of interest.

In this regard, it is noted that the data reconstructions are preferably performed after an acquisition of projection data. However, it might be possible to perform the data reconstruction also during the acquisition of projection data, i.e. perform the data reconstruction based on a first set of projection data while the next projection takes place. In this case, intermediate results can be visualized during further projections, which subsequently will lead to an optimization of the reconstruction and therefore to an optimization of a visualization.

With such a user interface, it might be possible to use one user interface with different preferably C-arm based acquisition devices. Connected to such a device, the user interface provides for visualization of reconstruction of a body together with a reconstruction of the body contour. Thus, the user interface might help a physician to guide a biopsy device precisely to the position of interest inside the body.

A method for 3D reconstruction of a body and of a body contour according to an embodiment of the invention, comprises the steps of reconstructing of a region of interest, reconstructing of a homogeneous polyhedron outside the region of interest, and optimizing the reconstructions after an acquisition of projection data, resulting in an optimized visualization of the body together with the body contour of the object of interest.

This method might be performed on an examination apparatus according to the invention.

Further, the invention relates to an image processing device for 3D reconstruction of a body and of a body contour, the image processing device being adapted for reconstructing of a region of interest, reconstructing of a homogeneous polyhedron outside the region of interest, optimizing the reconstructions after an acquisition of projection data, resulting in an optimized visualization of the body together with the body contour of the object of interest.

The invention relates also to a computer program for an image processing device, such that the method according to the invention might be executed on an appropriate system. The computer program is preferably loaded into a working memory of a data processor. The data processor is thus equipped to carry out the method of the invention. Further, the invention relates to a computer readable medium, such as a CD-Rom, at which the computer program may be stored. However, the computer program may also be presented over a network like the worldwide web and can be downloaded into the working memory of a data processor from such a network.

It has to be noted that embodiments of the invention are described with reference to different subject matters. In particular, some embodiments are described with reference to method type claims whereas other embodiments are described with reference to apparatus type claims. However, a person skilled in the art will gather from the above and the following description that, unless other notified, in addition to any combination of features belonging to one type of subject matter also any combination between features relating to different subject matters is considered to be disclosed with this application.

The aspects defined above and further aspects, features and advantages of the present invention can also be derived from the examples of embodiments to be described hereinafter and are explained with reference to examples of embodiments. The invention will be described in more detail hereinafter with reference to examples of embodiments but to which the invention is not limited.

Exemplary embodiments of the present invention will now be described in the following, with reference to following drawings.

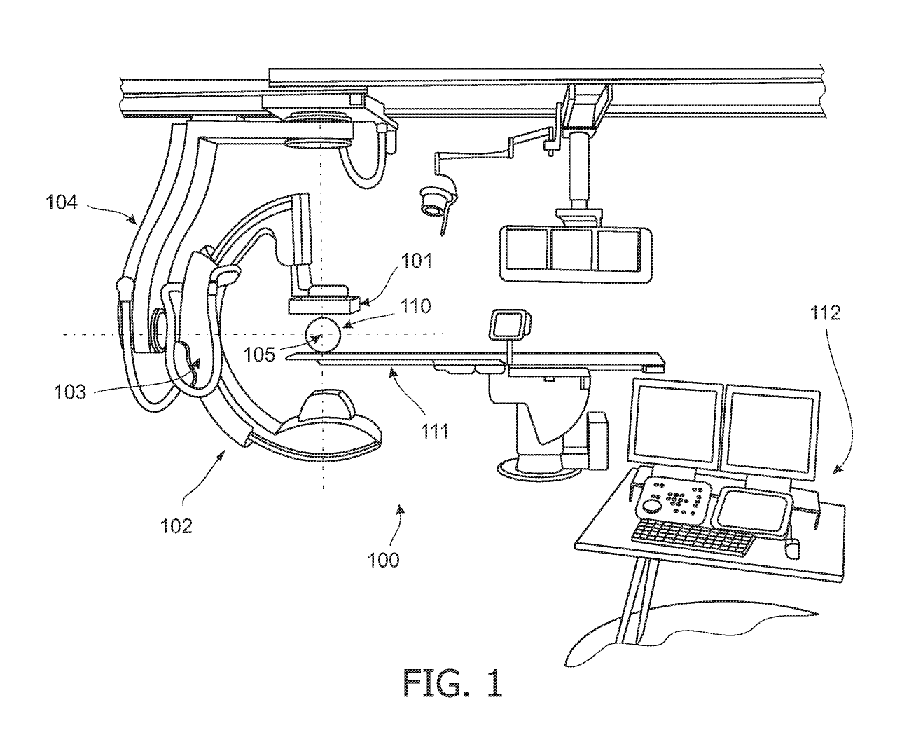

FIG. 1 shows an exemplary embodiment of an examination apparatus according to the present invention.

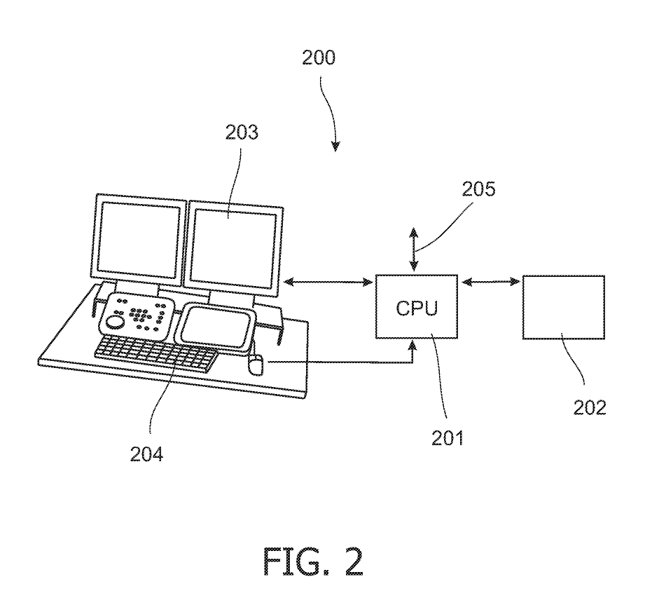

FIG. 2 shows an exemplary embodiment of an image processing device according to the present invention for executing an exemplary embodiment of a method in accordance with the present invention.

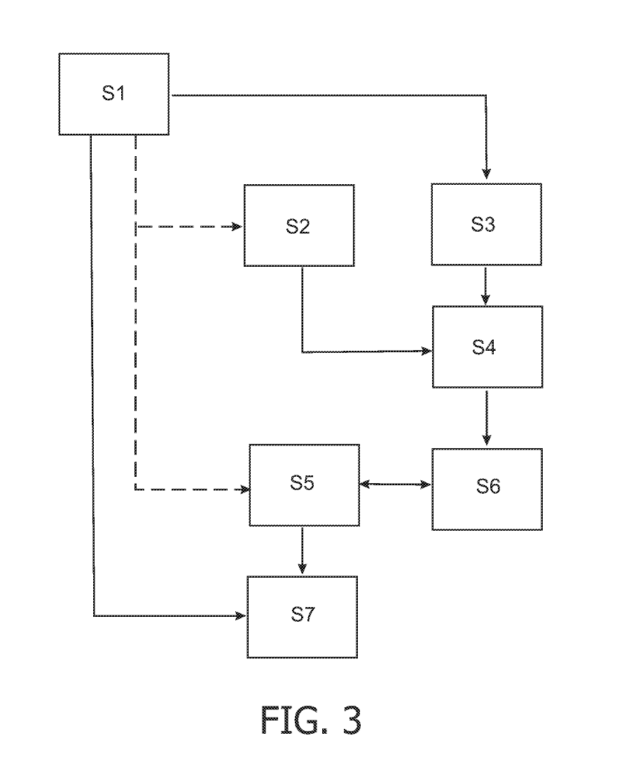

FIG. 3 shows a flow-chart of an exemplary embodiment according to the present invention.

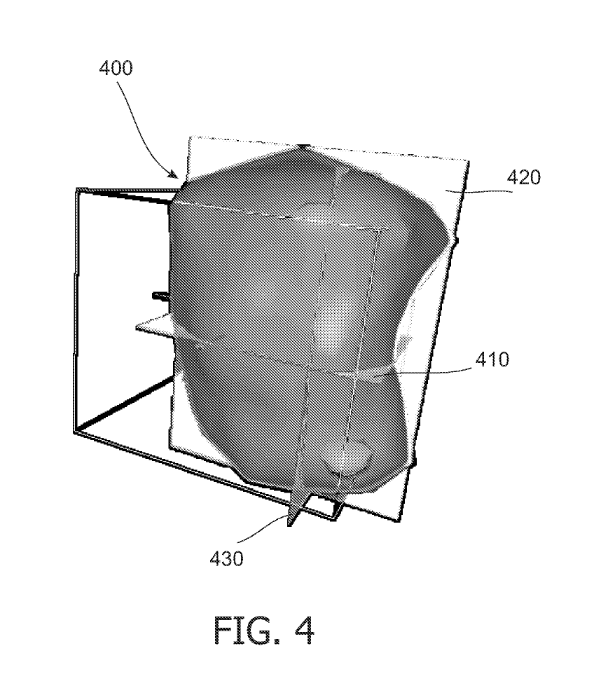

FIG. 4 shows an exemplary reconstruction of a homogeneous polyhedron.

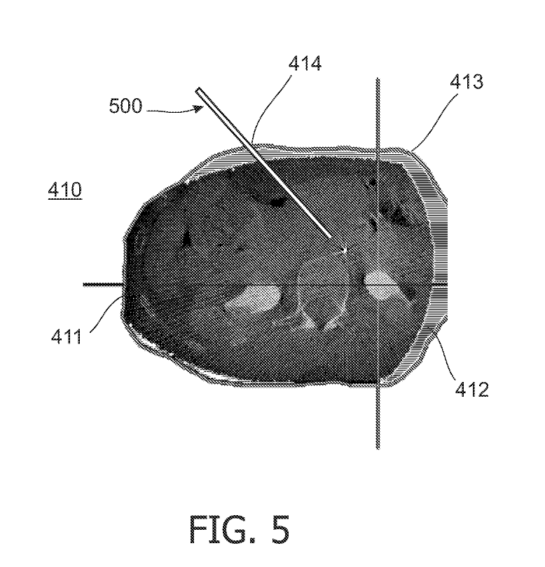

FIG. 5 shows an exemplary reconstruction of a region of interest and of a body contour together with a schematically illustration of a biopsy device.

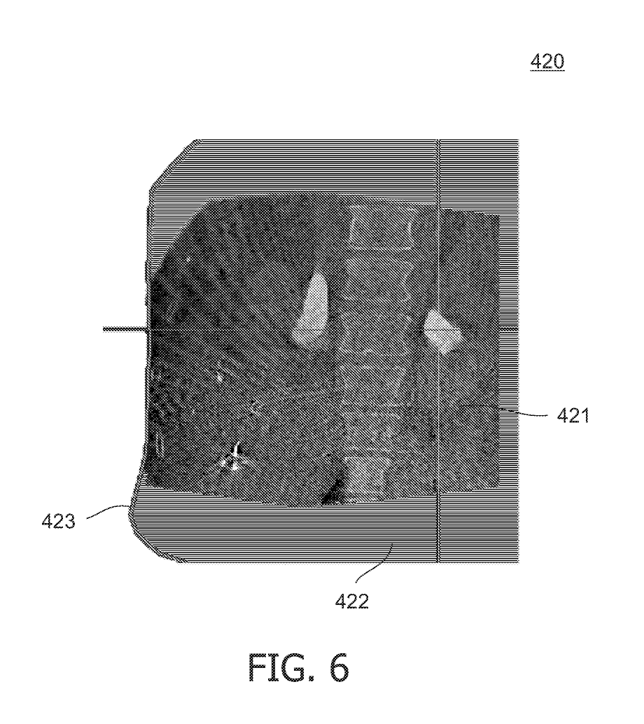

FIG. 6 shows another exemplary reconstruction of a region of interest and of a body contour.

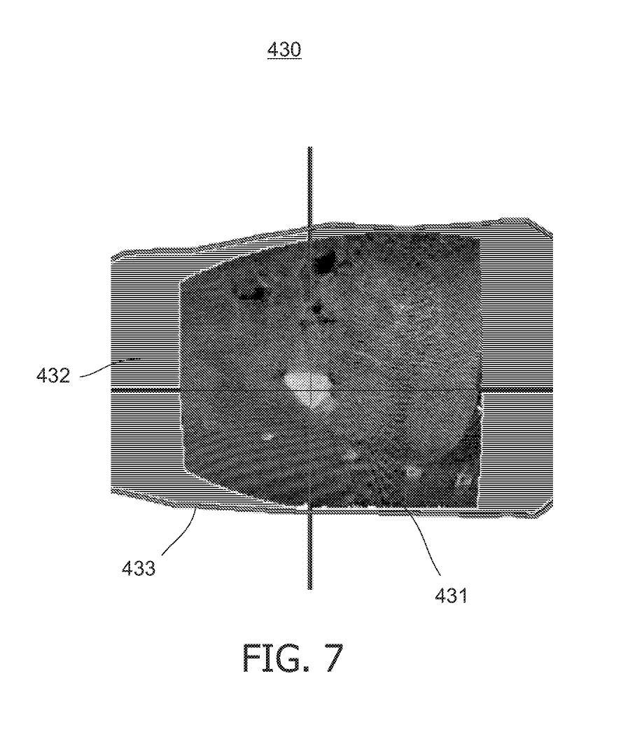

FIG. 7 shows a further exemplary reconstruction of a region of interest and of a body contour.

The illustration in the drawings is schematically. In different drawings, similar or identical elements are provided with the same reference numerals.

FIG. 1 shows a schematic representation of an exemplary rotational X-ray scanner, adapted as from a C-arm scanner according to an exemplary embodiment of the present invention. It should be noted however, that the present invention is not limited to rotational X-ray scanners.

An X-ray source 100 and a flat detector 101 with a large sensitive area are mounted to the ends of a C-arm 102. The C-arm 102 is held by curved rail, the “sleeve” 103. The C-arm can slide in the sleeve 103, thereby performing a “roll movement” about the axis of the C-arm. The sleeve 103 is attached to an L-arm 104 via a rotational joint and can perform a “propeller movement” about the axis of this joint. The L-arm 104 is attached to the ceiling via another rotational joint and can perform a rotation about the axis of this joint. The various rotational movements are effected by servo motors. The axes of the three rotational movements and the cone-beam axis always meet in a single fixed point, the “isocenter” 105 of the rotational X-ray scanner. There is a certain volume around the isocenter that is projected by all cone beams along the source trajectory. The shape and size of this “volume of projection” (VOP) depend on the shape and size of the detector and on the source trajectory. In FIG. 1, the ball 110 indicates the biggest isocentric ball that fits into the VOP. The object (e.g. a patient or an item of baggage) to be imaged is placed on the table 111 such that the object's volume of interest (VOI) fills the VOP. If the object is small enough, it will fit completely into the VOP; otherwise, not. The VOP therefore limits the size of the VOI.

The various rotational movements are controlled by a control unit 112. Each triple of C-arm angle, sleeve angle, and L-arm angle defines a position of the X-ray source. By varying these angles with time, the source can be made to move along a prescribed source trajectory. The detector at the other end of the C-arm makes a corresponding movement. The source trajectory will be confined to the surface of an isocentric sphere.

The C-arm x-ray scanner is adapted for performing an examination method according to the invention.

It should be noted that a C-arm x-ray scanner is particularly useful for intra-operational scans of an object of interest.

FIG. 2 shows an exemplary embodiment of a image processing device 200 according to the present invention for executing an exemplary embodiment of a method in accordance with the present invention. The image processing device 200 depicted in FIG. 2 comprises a central processing unit (CPU) or image processor 201 connected to a memory 202 for storing an image depicting an object of interest, such as a patient or an item of baggage. The image processor 201 may be connected to a plurality of input/output network or diagnosis devices, such as a CT device. The image processor 201 may furthermore be connected to a display device 203, for example, a computer monitor, for displaying information or an image computed or adapted in the image processor 201. An operator or user may interact with the image processor 201 via a keyboard 204 and/or other input devices.

The image processor 201, the memory 202, the display device 203, together with the input device 204 might substantially form a user interface according to the invention.

Furthermore, via the bus system 205, it may also be possible to connect the image processing and control processor 201 to, for example, a motion monitor, which monitors a motion of the object of interest. In case, for example, a lung of a patient is imaged, the motion sensor may be an exhalation sensor. In case the heart is imaged, the motion sensor may be an electrocardiogram.

FIG. 3 shows a flow-chart of an exemplary method according to the present invention.

In step S1, an attenuation function inside a region of interest is generated from a pre-recorded image. Such a pre-recorded image might preferably be a high resolution 3D-representation of at least the region of interest. The pre-recorded image may be computed from a CT acquisition or a similar device. Alternatively, a region of interest may be reconstructed using for example Filtered Back-Projection techniques from a rotational acquisition with a C-arm scanner.

In step S2, a few X-ray beams are emitted from a radiation source towards a detector, whereby a few projections are generated. By way of these projections, projection data are acquired, representing different angles relative to the object of interest. During said acquisition, information about the position of the radiation source and the detector relative to the object of interest, are recorded and respectively assigned to a corresponding projection. Alternatively, a subset of X-ray projections may be collected from the data acquisition of step S1.

In steps S3, S4, S5, and S6, a homogeneous polyhedron is reconstructed outside the region of interest. In detail, the named steps include the following aspects.

Based on the results of step S1, the reconstructed region of interest, i.e. a variable attenuation function is forward projected in step S3 into the acquisition geometry of step S2.

In step S4, the residual of the calculated data of step S3 and the measured data of step S2 is determined.

In step S5, the contribution of the region between the body contour, described by a homogeneous polyhedron, and the region of interest to the projection data is computed. To this end a constant attenuation function inside the region of interest is forward projected into the detector geometry of step S2. The result is then subtracted from the forward projection of the homogeneous polyhedron, which models the contour of the body.

That is, firstly an X-ray beam emitted from a radiation source towards a detector is selected and the intersection points between the beam and a polyhedral model are calculated. This calculation results in entry and exit points (in which the beam enters or exits the model), wherein the number of entry and exit points is an even number, in case no edge or anything similar is hit by the beam. Further, the distance which the beam travels through the object, i.e. the model, is calculated. It should be noted, that more than one entry point into the object of interest and more than one exit point from the object are possible. Finally, the line integral through the object along the X-ray beam is computed as the sum of distances, the X-ray travels through the object.

In the same way, the line integral through the region of interest along the X-ray beam can be computed. By subtracting the computed line integral through the region of interest from the line integral through the object, i.e. the model, the line integral along the X-ray through the region between the exterior body contour model and the region of interest can be computed.

Finally, in step S6, the residual between the results of step S4 and step S5 is minimized, for example on the basis of a gradient descent scheme, wherein also other minimization schemes may be used.

Mathematically, steps S3 to S6 include the following approaches and calculations for the reconstruction of a homogeneous polyhedron.

The optimizing of coordinates of the polyhedral model may be performed for example alternately or by optimizing of one unknown parameter X=(v₁, . . . , v_{N}, μ) which comprises the vertices or coordinates v₁, . . . , v_{N} of the surface model and the attenuation value μ.

Furthermore, it should be noted that the polyhedral model may consist of several sub-models, each of which endowed with its own vertices and attenuation value. In this case the unknown vector which is subject to the optimization procedure can be written as X=(X₁, . . . , X_{M}) with X=(v₁, . . . , v_{N}_{ᵢ}, μᵢ). In this sense, the term “polyhedral model” comprises compound models and the term “attenuation value” comprises a corresponding attenuation vector describing the attenuation coefficient in the sub-models of the compound polyhedral model.

As an examplary embodiment for reconstructing a homogeneous polyhedron the model may consist of two sub-models, one model X₁=(v₁, . . . , v_{N}_{₁}, μ₁) describing the body contour and the other model X₂=(v₁, . . . , v_{N}_{₂}, μ₂) describing the region of interest. For modelling the region between the body contour and the region of interest the attenuation values are related via μ₁=−μ₂.

3D reconstruction from a small number of projections is an active field of research and only partial results are known up to now. The invention is not limited to reconstruct a body contour and can also be applied to reconstruct bolus filled heart chambers. It is proposed to optimize a surface model by forward projecting the model and minimizing the residual between the forward projected model and the measured line-integrals. In case of reconstructing a body contour the model is optimized by minimizing the residual as computed in step S6. Since the proposed method is fully based on the physical model of attenuated X-rays non-convexities can easily be reconstructed in contrast to other methods, which are based on adapting the model to edge contours in the projections. Moreover, the presented modelling scheme reconstructs both the polyhedral shape and the attenuation of a homogeneous obstacle. Compared with voxel-based iterative reconstruction schemes, the polyhedral reconstruction is contour based which may result in a smaller number of unknowns due to the reduction of one dimension. Hence, the contour-based reconstruction may be faster than conventional voxel-based iterative algorithms.

The unknown object is modelled with a triangular surface mesh, where a rough first guess initializes the reconstruction procedure. The topology of the model must be known or guessed a priori and is often given together with a good initial mesh by the particular application such as heart, vessel or bone imaging. It should be noted that for reconstructing a body and a body contour for guided biopsies, an initial mesh may be generated from step S1, i.e. from a 3D reconstruction of the volume of interest. Then, the coordinates of the vertices are optimized in the reconstruction scheme. Additionally, the constant attenuation of the object is a further unknown, which is optimized alternately with the vertices. To stabilize the reconstruction and to avoid self-intersections and degenerated triangles, a variety of different penalty terms may be added to the data mismatch error term. For the speed up of the modelling scheme, a refinement scheme may be provided which starts with a coarse surface mesh and down-sampled projections. When the decrease of the penalty term is slowing down, the surface mesh may be refined and, if necessary, the projections are resampled. The regularization parameters may be controlled adaptively, too.

In the following a detailed description on an exemplary embodiment for reconstructing a homogeneous polyhedron according to the present invention is provided:

In addition to the contour reconstruction of a high-contrast object, the attenuation coefficient is reconstructed as well. To this end the unknown object is modelled via a triangular surface mesh with vertices V={vᵢ:i=1, . . . , N} and a vertex index list F={Fⱼₖ:j=1, . . . , M;k=1, 2, 3}, which defines M triangular faces Tⱼ=v_{F}_{ⱼ₁}V_{F}_{ⱼ₂}V_{F}_{ⱼ₃} ordered such that the corresponding face normal

$${n}_{j} = \frac{( {v}_{{F}_{j 2}} - {v}_{{F}_{j 1}} ) \times ( {v}_{{F}_{j 3}} - {v}_{{F}_{j 1}} )}{‖ ( {v}_{{F}_{j 2}} - {v}_{{F}_{j 1}} ) \times ( {v}_{{F}_{j 3}} - {v}_{{F}_{j 1}} ) ‖}$$

points into the exterior of the object for j=1, . . . , M . Together with the constant coefficient μ, these parameters constitute the model (μ, V, F). Here the attenuation μ and the vertex positions V are unknown while the ordering of the faces F is known in advance. For the reconstruction of the object model the attenuation μ is optimized alternately with the vertices vᵢ. To this end the residual between the measured projection values pₗ, l=1, . . . , L and the forward projection values qₗ=Aₗ(μ, V, F) of the model is computed together with additional penalty terms Rₜ(V,F):

$$J ( μ , V , F ) {\sum }_{l = 1}^{L} {( {p}_{l} - {q}_{l} )}^{2} + {\sum }_{t = 1}^{T} {λ}_{t} {R}_{t} ( V , F ) . \qquad ( 1 )$$

The forward projection of the model can be calculated via

$${A}_{l} ( μ , V , F ) = μ {\sum }_{i = 1}^{{I}_{l} / 2} ‖ {w}_{2 i}^{l} - {w}_{2 i - 1}^{l} ‖ \qquad ( 2 )$$

where the Iₗ intersections wᵢ^{l},i=1, . . . , I of the l-th ray with the surface triangles Tⱼ for j=1, . . . , M, of the polyhedron are ordered by increasing distance to the source location. In case of an uneven number of intersections Iₗ, the l-th ray is replaced with a parallel ray in the vicinity of the original ray. This situation may occur if the ray hits the object exactly in a vertex or intersects an edge of a triangular face.

For fixed vertex positions, the penalty terms are constant and the minimization of (1) boils down to the determination of the minimum of the parabola

$$P ( μ ) = {μ}^{2} {\sum }_{l = 1}^{L} {( {q}_{l}^{/} )}^{2} - 2 μ {\sum }_{l = 1}^{L} {q}_{l}^{/} {p}_{l} + {\sum }_{l = 1}^{L} {p}_{l}^{2} \qquad ( 3 )$$

with

$${q}_{l}^{/} = {\sum }_{i = 1}^{{I}_{l} / 2} ‖ {w}_{2 i}^{l} - {w}_{2 i - 1}^{l} ‖ .$$

In this case, the unique minimizer of functional (1) is given by the minimizer

$$μ = \frac{{\sum }_{l = 1}^{L} {q}_{l}^{/} {p}_{l}}{{\sum }_{l = 1}^{L} {( {q}_{l}^{/} )}^{2}} \qquad ( 4 )$$

of the parabola (3). On the other hand, for a fixed attenuation coefficient μ the functional (1) may be minimized using the following gradient descent scheme:

1. Compute the gradient G=∇J(μ,V,F) of (1) with respect to the vertices V numerically.

2. Define a one-dimensional optimization problem via the surrogate functional \tilde{J}(s)=J(μ,V−sG,F).

3. Approximate \tilde{J}(s) by a parabola \tilde{P}(s) such that
a. \tilde{P}(0)=\tilde{J}(0), i.e. \tilde{P}(0)=J(V),
b. \tilde{P}′(0)=\tilde{J}′(0), i.e. \tilde{P}′(0)=−∥G∥²
c. \tilde{P}(t)=\tilde{J}(t), for a suitable t≠s.

4. Update V=V−sG, where s is the unique minimizer of the parabola \tilde{P}.

According to an aspect of the present invention, the polyhedral model comprises vertices having coordinates, wherein the polyhedral model comprises a topology connecting at least one of the vertices to a face of a surface of the polyhedral model. Further, the examination apparatus according to the invention comprises a calculation unit adapted for performing the steps of optimizing (for example alternately) the coordinates of the polyhedral model and an attenuation function of the polyhedral model during a data reconstruction, resulting in an optimized attenuation value together with a surface model of the object of interest.

It should be noted that the topology may connect each one of the vertices with a corresponding surface of the model. However, for performing the modelling of the polyhedral model, not all of the vertices may have to be connected to a respective surface.

It should be noted that optimizing of coordinates of the polyhedral model may be performed for example alternately or by optimizing of one unknown parameter X=(v₁, . . . , v_{N}, μ) which comprises the vertices or coordinates v₁, . . . , v_{N} of the surface model and the attenuation value μ.

Furthermore, it should be noted that the polyhedral model may consist of several sub-models, each of which endowed with its own vertices and attenuation value. In this case the unknown vector which is subject to the optimization procedure can be written as X=(X₁, . . . , X_{M}) with X=(v₁, . . . , v_{N}_{ᵢ}, μᵢ). In this sense, the term “polyhedral model” comprises compound models and the term “attenuation value” comprises a corresponding attenuation vector describing the attenuation coefficient in the sub-models of the compound polyhedral model.

In order to prevent for degradation or degeneracy, small steps may be performed or/and suitable regularization terms may be implemented.

For stabilizing the iterative reconstruction procedure the following penalty terms might been chosen:

1. deviation of vertices from barycentre of neighbours (favouring flat surfaces)

$${R}_{1} ( V , F ) = {\sum }_{j = 1}^{N} {‖ {v}_{j} - {b}_{j} ‖}^{2} \qquad ( 5 )$$

with the barycentre

$${b}_{j} = \frac{1}{K} {\sum }_{k = 1}^{{K}_{j}} {v}_{k , j}$$

of the Kⱼ neighbours v_{k,j} of the vertex vⱼ in the mesh (V,F),

2. deviation of face area from average triangle area in the mesh

$${R}_{2} ( V , F ) = {\sum }_{k = 1}^{M} {( \begin{matrix}\frac{1}{2} ‖ ( {v}_{{F}_{k 2}} - {v}_{{F}_{k 1}} ) \times ( {v}_{{F}_{k 3}} - {v}_{{F}_{k 1}} ) ‖ - \\ \frac{1}{M} {\sum }_{j = 1}^{M} ‖ ( {v}_{{F}_{j 2}} - {v}_{{F}_{j 1}} ) \times ( {v}_{{F}_{j 3}} - {v}_{{F}_{j 1}} ) ‖\end{matrix} )}^{2} \qquad ( 6 )$$

3. penalty term for kissing triangles

$${R}_{3} ( V , F ) = {\sum }_{k = 1}^{N} {\sum }_{j = 1}^{{J}_{k}} {( \frac{1}{2} - \frac{1}{2} {n}_{j , k} \times {n}_{j + 1 , k} )}^{4} \qquad ( 7 )$$

with the convention that n_{J}_{ₖ}_{+1,k}=n_{1,k}, where Jₖ is the number of adjacent faces at vertex vₖ,

4. deviation from regular triangles

$${R}_{4} ( V , F ) = {\sum }_{k = 1}^{M} {( 1 - cos ( \frac{π}{3} - {α}_{k} ) cos ( \frac{π}{3} - {β}_{k} ) cos ( \frac{π}{3} - {γ}_{k} ) )}^{2} \qquad ( 8 )$$

where αₖ,βₖ, γₖ are the three angles of the triangle Tₖ.

The corresponding regularization parameters λ₁, . . . , λ₄ are controlled during the iteration to guide the optimization procedure. To this end, a first choice of the regularization parameters is made such that the sum of all penalty terms is between 10%-50% of the residual without any additional penalty term. After a fixed number of iterations, the ratio of the penalty terms and the sole residual is checked and adapted if it is out of the range from 10%-50%. Similarly, a regularization parameter is updated if the corresponding penalty term is significantly larger/smaller than the average penalty term. With this parameter choice a self-intersection or degeneration of the polyhedral object model can be avoided. In order to minimize the mismatch in the projection data, the ratio between penalty terms and projection mismatch is successively reduced, whenever the mesh is refined.

For the reconstruction of a compound polyhedral model consisting of M sub-models X=(v₁, . . . , v_{N}_{ᵢ}, μᵢ), i=1, . . . , M, the forward projector may be redefined as

$${q}_{l} = {\sum }_{i = 1}^{M} {A}_{l} ( {μ}_{i} , {V}_{i} , {F}_{i} ) ,$$

i.e. as the sum of contributions from each sub-model, and hereby redefines the object function (1). In this case the computation (4) of the attenuation values μᵢ, i=1, . . . , M is replaced by solving the linear system of equations:

$$( \begin{matrix}{\sum }_{l = 1}^{L} {A}_{l} ( {μ}_{1} , {V}_{1} , {F}_{1} ) {A}_{l} ( {μ}_{1} , {V}_{1} , {F}_{1} ) & ⋯ & {\sum }_{l = 1}^{L} {A}_{l} ( {μ}_{1} , {V}_{1} , {F}_{1} ) {A}_{l} ( {μ}_{M} , {V}_{M} , {F}_{M} ) \\ ⋮ & ⋱ & ⋮ \\ {\sum }_{l = 1}^{L} {A}_{l} ( {μ}_{M} , {V}_{M} , {F}_{M} ) {A}_{l} ( {μ}_{1} , {V}_{1} , {F}_{1} ) & ⋯ & {\sum }_{l = 1}^{L} {A}_{l} ( {μ}_{M} , {V}_{M} , {F}_{M} ) {A}_{l} ( {μ}_{M} , {V}_{M} , {F}_{M} )\end{matrix} )$$

$$( \begin{matrix}{μ}_{1} \\ ⋮ \\ {μ}_{M}\end{matrix} ) = ( \begin{matrix}{\sum }_{l = 1}^{L} {A}_{l} ( {μ}_{1} , {V}_{1} , {F}_{1} ) {P}_{l} \\ ⋮ \\ {\sum }_{l = 1}^{L} {A}_{l} ( {μ}_{M} , {V}_{M} , {F}_{M} ) {P}_{l}\end{matrix} )$$

for example with a Cholesky decomposition.

Each of the sub-models may be penalized with one or more regularization terms (5)-(8) (cf. above). Moreover, additional penalty terms may be introduced in order to control inter-object behavior of the sub-models.

It should be noted that the model may consist of two sub-models, one model X=(v₁, . . . , v_{N}_{ᵢ}, μᵢ) describing the body contour and the other model X₂=(v₁, . . . , v_{N}_{₂}, μ₂) describing the region of interest. For modelling the region between the body contour and the region of interest the attenuation values are related via μ₂=μ₂. Furthermore, the measured projection values pᵢ in equation (1) may be given by the residual computed in step S6, which is computed as the measured line-integral data of step S2 minus the forward projected attenuation function of step S3.

In other words, an examination apparatus is provided in which a polyhedral model of for example a body contour may be modelled. The modelling is performed in an iterative manner in which the coordinates of the vertices of the polyhedral model and the attenuation function or attenuation value of the model are optimized. Thus, the attenuation function or value does not have to be known in advance.

There may be no principle restrictions on the geometrical setup of the data acquisition and the modelling may even be capable of reconstructing severely non-convex objects and body contours. Besides an application for guiding biopsies, possible clinical applications comprise high-contrast imaging of coronary veins and ventricles in rotational angiography, orthopaedic imaging of bones and joints and the reconstruction of deformable medical devices. Furthermore, this aspect of the method according to the invention may be easily applicable in the field of digital subtraction angiography. Since the underlying reconstruction algorithm is of iterative nature, the invention may be suited for a variety of acquisition geometries such as rotational runs, dual axis movements and acquisitions which are geometrically limited to gather only few projections.

The object of interest may be modelled as a polyhedron with triangular surface mesh. Although the topology of the model does not change during iteration, the method may easily reconstruct even non-convex shapes. Often an application-specific model such as a body model, heart, vessel, or bone model is available to initialize the iterative procedure and to improve the convergence of the algorithm. However, the method may also be capable of reconstructing arbitrary polyhedron structures from simple spherical initial meshes by stabilizing the reconstruction with suitable regularization terms.

The algorithm exploits a gradient descent scheme in order to minimize the object function which consists of a data fit term and additional penalty terms to stabilize the reconstruction procedure. Both the vertices of the polyhedral object and its attenuation value are optimized during the algorithm.

The result may be an attenuation value together with a 3D surface model of the physical structure that has been imaged with X-rays. Compared to voxel-based reconstruction techniques a further segmentation is not necessary. Hence, the reconstructed model may immediately be used both for visualization and further computations (heart volume, bone thickness, vessel diameter) without any additional image processing.

According to another exemplary embodiment of the present invention, the polyhedral model comprises a triangular surface mesh. It should be noted, that the present invention is not limited to triangular surface meshes. However, such a triangular surface mesh may provide for a fast and efficient modelling.

According to another exemplary embodiment of the present invention, the calculation unit is further adapted for performing the step of stabilizing the reconstruction by adding at least one penalty term to a data mismatch error term.

It should be noted that no regularization or stabilization may be required in case the starting model is of sufficient quality. Furthermore, other penalty terms may be used for stabilization or regularization.

Such a stabilization may prevent a degeneracy of the model.

For example, according to another exemplary embodiment of the present invention, the at least one penalty term is selected from the group comprising a deviation of vertices from a barycenter of neighbours, a deviation of a face area from an average triangle area in the mesh, a penalty term for kissing triangles, and a deviation from regular triangles.

Furthermore, according to another exemplary embodiment of the present invention, the attenuation value is fixed during the optimization of the coordinates of the polyhedral model, during which a minimization of a residual between measured projection values and calculated forward projection values is performed.

According to another exemplary embodiment of the present invention, the minimization comprises a gradient descent scheme.

According to another exemplary embodiment of the present invention, the coordinates of the polyhedral model are fixed during the optimization of the attenuation value, during which a minimum of the following function is determined:

$$P ( μ ) = {μ}^{2} {\sum }_{l = 1}^{L} {( {q}_{l}^{/} )}^{2} - 2 μ {\sum }_{l = 1}^{L} {q}_{l}^{/} {p}_{l} + {\sum }_{l = 1}^{L} {p}_{l}^{2}$$

with

$${q}_{l}^{/} = {\sum }_{i = 1}^{{I}_{l} / 2} ‖ {w}_{2 i}^{l} - {w}_{2 i - 1}^{l} ‖ ,$$

or, in case of a compound polyhedral model, a solution of the linear system

$$( \begin{matrix}{\sum }_{l = 1}^{L} {A}_{l} ( {μ}_{1} , {V}_{1} , {F}_{1} ) {A}_{l} ( {μ}_{1} , {V}_{1} , {F}_{1} ) & ⋯ & {\sum }_{l = 1}^{L} {A}_{l} ( {μ}_{1} , {V}_{1} , {F}_{1} ) {A}_{l} ( {μ}_{M} , {V}_{M} , {F}_{M} ) \\ ⋮ & ⋱ & ⋮ \\ {\sum }_{l = 1}^{L} {A}_{l} ( {μ}_{M} , {V}_{M} , {F}_{M} ) {A}_{l} ( {μ}_{1} , {V}_{1} , {F}_{1} ) & ⋯ & {\sum }_{l = 1}^{L} {A}_{l} ( {μ}_{M} , {V}_{M} , {F}_{M} ) {A}_{l} ( {μ}_{M} , {V}_{M} , {F}_{M} )\end{matrix} )$$

$$( \begin{matrix}{μ}_{1} \\ ⋮ \\ {μ}_{M}\end{matrix} ) = ( \begin{matrix}{\sum }_{l = 1}^{L} {A}_{l} ( {μ}_{1} , {V}_{1} , {F}_{1} ) {P}_{l} \\ ⋮ \\ {\sum }_{l = 1}^{L} {A}_{l} ( {μ}_{M} , {V}_{M} , {F}_{M} ) {P}_{l}\end{matrix} )$$

is computed.

According to another exemplary embodiment of the present invention, the examination apparatus is adapted as one of a three-dimensional computed tomography apparatus, a three-dimensional rotational X-ray apparatus, and an orthopaedic X-ray imaging apparatus. For example, the examination apparatus is a C-arm system.

According to another exemplary embodiment of the present invention, the examination apparatus is adapted for being applied in the field of digital subtraction angiography.

According to another exemplary embodiment of the present invention, the attenuation function is piecewise constant.

According to another exemplary embodiment of the present invention, the data reconstruction is performed during or after an acquisition of projection data of the object of interest, wherein a result of the reconstruction is visualized during or after the acquisition.

According to another exemplary embodiment of the present invention, the visualized result comprises at least one of an intermediate image and an intermediate attenuation function.

For example, the intermediate surface model may be visualized or otherwise analyzed after each or a predetermined number of optimization steps during the iterative reconstruction. Furthermore, or alternatively, the attenuation function or simply the attenuation value may be visualized or otherwise analyzed, independently from the intermediate surface model.

Therefore, the intermediate results may be evaluated during the iterative reconstruction, thus allowing for a correction of the reconstruction after having the results analyzed. Such analysis may be performed by comparison of the intermediate result with a projection, thus providing a feedback of the quality of the model. In other words, the convergence quality of the iterative reconstruction may be tracked, for example visually.

According to another exemplary embodiment of the present invention, a user interface might be provided for visualization of an intermediate result of a data reconstruction of, for example, the above described polyhedral model of an object of interest, wherein the visualization and the data reconstruction are performed during an acquisition of projection data of the object of interest.

Such a user interface may comprise a display or a monitor for visualizing the intermediate result. After each iteration the surface of the model is displayed such that the convergence of the iterative reconstruction may be graphically (visually) tracked by the user. By projecting the intermediate model in or after each iteration step on a single projection, a visual feedback relating to the quality of the model may be provided.

Thus, contrary to an image segmentation, not only a surface model may be generated which is optimally adapted (to the object of interest), but also a corresponding (intermediate) absorption coefficient or attenuation function is generated, such that all line integrals through the object belonging to a projection have the smallest difference to the measured data. Such a coefficient or function may not be provided by a normal segmentation process.

According to another exemplary embodiment of the present invention, the visualized intermediate result comprises at least one of an intermediate image and an intermediate attenuation function.

According to another exemplary embodiment of the present invention, the data reconstruction is an iterative data reconstruction.

According to another exemplary embodiment of the present invention, a method might be provided for modelling a polyhedral model of an object of interest, wherein the polyhedral model comprises vertices having coordinates, wherein the polyhedral model comprises a topology connecting at least one of the vertices to a face of a surface of the polyhedral model, and wherein the method comprises the steps of alternately optimizing the coordinates of the polyhedral model and optimizing an attenuation function of the polyhedral model during a data reconstruction, resulting in an optimized attenuation value together with a surface model of the object of interest.

Finally, the method according to the invention is completed in step S7, by a combined visualization of the reconstructed surface mesh as a result of the reconstruction of a homogeneous polyhedron, onto the reconstruction of the region of interest.

In FIG. 4, an example for a homogeneous polyhedron 400 is depicted. It is noted that the surface of said polyhedron might also be illustrated at least partially transparent or semi-transparent, to provide for a better relation of the inner structures of the body, which might be visualized on planes 410, 420 and 430, and the outer contour of the body.

In FIGS. 5, 6, and 7, examples for another way of illustration of the inner structures together with the outer contour are shown.

In FIG. 5, plane 410 is shown, representing an axial view. On said plane, the reconstruction of the region of interest 411, a region 412 between the region of interest and the body contour which results from the truncated projections, and a line 413 is depicted, the line 413 representing the outer contour of the body.

Additionally, a biopsy device 500 is schematically introduced in FIG. 5. As long as it is known, at which point 414 the biopsy device is introduced into the body, at which angle the biopsy device is moved forward, and to which length the biopsy device is introduced, it is possible to well estimate the current position of the tip of the biopsy device inside the region of interest relative to the outer contour of the body.

Furthermore, since it is possible to generate new scans intra-operatively, a physician might be further supported by several new reconstructions beside the mechanical information (length, angle, position), wherein these reconstruction might show also the biopsy device inside the body.

In FIG. 6, plane 420 is shown, representing a coronal view. Also here, the region of interest 421 inside the body, a region 422 outside the region of interest and inside the body contour, together with a line 423 is illustrated, which represents the outer contour of the body.

In FIG. 7, plane 430 is shown, representing a sagittal view. The region of interest is denoted by the reference sign 431. The region without sufficient projection information, surrounding the region 431, is denoted by the reference sign 432. The contour of the body, generated as an outline of the reconstructed homogeneous polyhedron, is denoted by the reference sign 433.

It should be noted that the term “comprising” does not exclude other elements or steps and the “a” or “an” does not exclude a plurality. Also elements described in association with different embodiments may be combined.

It should also be noted that reference signs in the claims shall not be construed as limiting the scope of the claims.

1. Examination apparatus (100) for 3D reconstruction of a body and of a body contour of an object of interest,
wherein the examination apparatus comprises
an data acquisition device (101) for acquisitioning of projection data of the object of interest,
a calculation unit (112) adapted for generating a reconstruction of a region of interest (411, 421, 431), and a reconstruction of a homogeneous polyhedron (400, 413, 423, 433) outside the region of interest, and
a display device for displaying a combined visualization of the reconstructed region of interest and the reconstructed polyhedron.

2. Examination apparatus (100) according to claim 1, wherein the reconstruction of the homogeneous polyhedron (400, 413, 423, 433) includes forward projecting of a reconstructed attenuation function of the region of interest, subtracting the result from the acquired projection data to generate a target function, forward projecting of a polyhedral model consisting of a body contour sub-model and a region of interest sub-model with constant attenuation function inside each of the sub-models, and optimization of the polyhedral model by minimization of the residual between the forward projected model and the target function.

3. User interface (200) for visualization of 3D reconstruction of a body and of a body contour,
wherein the visualization and the data reconstructions are performed after an acquisition of projection data of the object of interest.

4. A method for 3D reconstruction of a body and of a body contour, wherein the method comprises the steps of:
reconstructing of a region of interest,
reconstructing of a homogeneous polyhedron outside the region of interest,
optimizing the reconstructions after an acquisition of projection data, and
visualizing of the body together with the body contour of the object of interest.

5. The Method according to claim 4,
wherein the step of reconstructing of a homogeneous polyhedron includes the steps of
forward projecting of a reconstructed attenuation function of the region of interest,
subtracting the result from the acquired projection data to generate a target function,
forward projecting of a polyhedral model consisting of a body contour sub-model and a region of interest sub-model with constant attenuation function inside each of the sub-models, and,
wherein the step of optimizing the reconstructions after an acquisition of projection data includes an optimization of the polyhedral model by minimization of the residual between the forward projected model and the target function.

6. A computer-readable medium, in which a computer program for 3D reconstruction of a body and of a body contour is stored;
wherein the computer-readable medium, when executed by a processor, causes the processor to carry out the steps of:
reconstructing of a region of interest,
reconstructing of a homogeneous polyhedron outside the region of interest,
optimizing the reconstructions after an acquisition of projection data, resulting in an optimized visualization of the body together with the body contour of the object of interest.

7. An image processing device for 3D reconstruction of a body and of a body contour, the image processing device being adapted for:
reconstructing of a region of interest,
reconstructing of a homogeneous polyhedron outside the region of interest,
optimizing the reconstructions after an acquisition of projection data, resulting in an optimized visualization of the body together with the body contour of the object of interest.
